(19) United States
(12) Patent Application Publication
(10) Pub. No.: US 2010/0165562 A1
(43) Pub. Date: Jul. 1, 2010

(54) MEMORY MODULE

(76) Inventor: Para Kanagasabai Segaram, Queensland (AU)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/160,769

(22) PCT Filed: Jan. 12, 2007
(86) PCT No.: PCT/AU2007/000017

§ 371 Date: Jul. 11, 2008

Related U.S. Application Data
(60) Provisional application No. 60/758,183, filed on Jan. 12, 2006.
(60) Provisional application No. 60/776,144, filed on Feb. 23, 2006.
(60) Provisional application No. 60/794,916, filed on Apr. 26, 2006.
(60) Provisional application No. 60/843,929, filed on Sep. 12, 2006.

(51) Int. Cl. G06F 1/16

(52) U.S. Cl. 361/679.31

(57) ABSTRACT

A sub system for a computing device comprising a plurality of chips mounted on a foldable substrate wherein the foldable substrate and the chips are layered by folding the substrate whereby the chips are disposed in at least one stacked configuration and wherein the sub system is adapted to be received on a host board. In addition, removable connections using resilient and nanostructure based members.

### FIELD OF THE INVENTION

The present invention relates to a sub system for computing devices. In particular, the present invention relates to the architecture of such sub systems. The present invention has particular application to memory modules but it will be appreciated that the invention will find other application to computing devices. In addition, the present invention relates to the removable connection of elements of a computing device.

### BACKGROUND OF THE INVENTION

Computing sub systems often limit the processing speed of computing devices because of a variety of physical limitations which limits the access speed of those subsystems. The present invention will now be described with reference to the manufacture of computer memory, in particular memory modules. However it will be appreciated that the present invention will be applicable to other computing subsystems. For example, communication subsystems including an analog transceiver along with a number of digital devices and an optical transceiver. Many other useful applications such as in medical devices using the small form factor devices, cellular phone, personal digital assistant, consumer devices and others will be apparent to those skilled in the art.

In the area of memory for computer devices, the operating speed of computer memory has lagged significantly behind the operating speed of the micro processor. This condition has been referred to as the “memory bottleneck” for many years. The physical limits of transistor technology as employed in the architecture used for the current generation of memory systems significantly limit the ability of those memory systems to provide improved operating speed.

Computer memory is accessed and stored at a variety of different locations in a computing device. On a computer motherboard, for example, a Level 1 cache is located on the IC chip, Level 2 memory is located in, or very near to, the CPU package and Level 3 memory, or main memory, is located in nearby memory modules. In order to access the main memory, high speed differential data lines are commonly used to transmit signals between the memory controller and the main memory of a computer or video module or plug-in card. In practice, the speed or performance of a computer is very often more limited by the capabilities of the high speed differential line between the memory and memory controller and the architecture of which rather than by the operating speed of the micro processor. Accordingly, it is being considered desirable in order to improve the performance of a computer or video system to design lower power, high speed differential lines that will enable increased speed of access to the memory.

Approaches that have been employed to improve the speed of access to the memory in fully buffered memory differential line structures have been limited to the standard circuit traces/electrical connectors that are currently used as an integral part of the interconnection of the memory modules to the memory controller. Because Advanced Memory Buffer (AMB) devices operate at high speed, high power, with large silicon areas and complex transceiver implementations the current approaches for improving the speed of access to the memory are limited.

The current approach to memory module architecture for use as main memory on a computer motherboard is for the memory module to be in the form of a board having a linear array of memory chips, such as DRAM chips, typically with a centrally disposed memory buffer chip (AMB). The memory board has connectors disposed along one side of the memory board so that the board can be edge mounted into a correspondingly shaped socket. The construction of the memory boards and of their edge mounting provide advantages in that the memory board has only a small footprint on the motherboard and permits thermal control of the memory board with the memory board acting as a thermal fin. A typical architecture for a main memory module is shown in FIG. 1 along with a typical connector.

This type of architecture, even when designed for high-speed memory module cards, places a number of physical limitations that limit the access speed to the memory.

In developing the memory module of the present invention various connections were also developed and we have found a variety of removable connections using resilient and nanostructure based members that provide significant advantages over the connections in the prior art.

It is therefore an object of the present invention to provide a memory module and a connection system which may at least partially overcome one or more of the above disadvantages or may provide the public with a useful choice.

### DESCRIPTION OF THE INVENTION

We have now found a memory architecture that provides for high access speed and low powered signalling between the memory module and the memory controller. According to a first aspect of the present invention, there is provided a sub system for a computing device comprising a plurality of chips mounted on a foldable substrate wherein the foldable substrate and the chips are layered by folding the substrate whereby the chips are disposed in at least one stacked configuration and wherein the sub system is adapted to be received on a host board.

In a preferred embodiment of the present invention the sub system is a memory module for a computing device. In this embodiment there is provided a memory module for a computing device comprising a plurality of memory chips mounted On a foldable substrate wherein the foldable substrate and the memory chips are layered by folding the substrate whereby the memory chips are disposed in at least one stacked configuration and wherein the memory module is adapted to be received on a host board.

We have found that with this memory architecture, it is possible to provide any memory module with much faster access speeds as well as a module that can operate with lower power between the memory modules, such as DIMM (Dual In-line Memory Module) modules, and the memory controller.

The present invention relates to a memory module for a computing device. It will be appreciated by those skilled in the art that the present invention will find application across a wide variety of computing devices. Without limitation, the memory module of the present invention may be used on processor subsystems (both single and dual cores) such as may be used on personal computers (both laptop and desktop), high end file servers and communication devices, high end memory, high end three dimensional graphics cards, as well as games consoles and others.

The memory module of the present invention includes a plurality of memory chips. They memory chips for use in the present invention may be of any convenient configuration. We have found DRAM to be particularly suitable for use with of the present invention although it is envisaged that other memory chips such as flash memory or bubble memory would also be suitable.

The memory chips for use in the memory module of the present invention are mounted on a substrate. The substrate may be of a number of convenient configurations. For example, the substrate may be a printed circuit board (PCB), organic substrates or other suitable substrates as will be apparent to those skilled in the art having regard to the manner in which the substrate and memory chips layered.

The substrate is foldable. It will be appreciated that by “foldable” it is meant that the substrate is formed from a material that is itself foldable or alternatively is formed from segments that are connected by a foldable connection. The foldable connection may be a modified form of the segments supporting the chips, such as a region of reduced thickness as would be the case with an integral hinge, or of modified composition that imparts a flexible property on the substrate at the foldable connection. The foldable connection may be a flexible element connecting the segments supporting the chips that provides physical and electrical connection between the respective segments that support the chips.

In one embodiment, the substrate may be formed from a single element that is sufficiently flexible to enable the substrate to be folded whilst maintaining physical and electrical connection between the memory chips. In this embodiment the fold lines may be positioned between the memory chips in any desired configuration. In an alternative embodiment, the substrate may be formed from segments supporting the memory chips interconnected by foldable elements such as flex that provide both physical and electrical connection between the respective segments. The foldable elements may be positioned so that the substrate may be folded to provide the desired stacking arrangement for the memory chips.

In the memory module of the present invention the substrate and the memory chips are layered whereby the memory chips disposed in at least one stacked configuration. The stacked configuration in which the memory, chips are disposed maybe a single stack or maybe multiple stacks. We have found that with the geometry of the foldable substrate is convenient to fold the substrate such that there two or four stacks of memory chips in the memory module. By folding the substrate so that there two or four stacks of memory chips, we have found that the desired packing efficiency is obtained whilst maintaining the ability to remove the heat from the memory module.

The memory module of the present invention is adapted to be received on a host board. Whilst we envisage that the memory module of the present invention could the mounted on a host board through a socket of similar configuration to those used to receive memory boards of current configurations, the layered memory module of the present invention is particularly suited to mounting on a host board utilizing a chip to board connection or a board to board connection that may be made using flexible cables and nano-structured materials such as carbon nanotubes and/or carbon nanowires.

We have found that the memory module produced according to the first aspect of the present invention can be mounted on a host board in flat connection, By mounting a the memory module in this way the memory buffer can be directly connected to the host board, avoiding the need to employ a pin in the socket connection. By connecting the memory buffer, such as by a temporary or permanent connection that reduces or eliminates discontinuities. the connection between the memory buffer and the memory controller can be optimized. Suitable connections between the memory buffer and the host board include gold dot press mounting, solder balls, or other connections that minimise discontinuities.

According to a second aspect of the present invention there is provided a memory module for a computing device comprising a memory buffer and a plurality of memory chips wherein. the memory buffer is mounted on a host board with a flat connection whereby the memory buffer is directly connected to the host board.

In the second aspect of the present invention, the flat connection between the memory buffer and the host board is preferably using gold dot press mounting, solder balls, or other electrical connections that enable the memory buffer to be directly. connected to the host board whereby discontinuities are reduced or eliminated.

By connecting the memory buffer to the host board in this way, the connection between the memory buffer and they memory controller mounted on the host board can be improved whereby the processing speed of the computing device can be substantially improved as well as reducing the power requirements of the memory buffer. By reducing the power consumption of the memory buffer, significant advantages can be obtained in portable computing such as with laptop computers, personal digital assistants, cellular phones as well as many other portable computing devices. The power consumed by the memory power is a significant contributor to the draining of power from the battery pack. In addition, the need to attenuate the thermal build-up around the memory buffer requires considerable space which is often not available. Accordingly compromise is have to be made in balancing the power supply to the memory buffer and the performance of the computer. In this aspect of the present invention we are able to provide a significant reduction in the power requirement for the memory buffer and accordingly reduce the need for thermal attenuation.

In this aspect of the present invention a communication channel of a memory system is provided consisting of high speed physical channels interposed between a memory controller and a memory buffer device.

This aspect of the present invention may also provide substantial improvement in the following aspects of memory system performance:

Point-to-point connections between devices allowing higher electrical switching performance

An extremely fast (>2.5 Gbit/pin) channel between the controller and AMB which has substantial margin for improvement beyond 2.5 Gbit/pin.

Scalability in both bandwidth and memory size via simple change out of the DRAMs assemblies instead of large design changes and design cycles. Controller and AMBs remain unchanged as bandwidth capability increases.

Simplified memory module design

In this aspect of the present invention, reliable reception of data is achieved, by adequate margin in the data delivery timing budget. Even though the present aspect does not rely upon special pre-emphasized drivers or receivers, the interconnect channel and circuit topology is critical for reliable data transfer.

This aspect of the present invention is designed to reduce circuit complexity in the Controller and AMB IC, while, at the same time, providing excellent data capture margins. As illustrated, write data from the memory controller is sent to a particular AMB IC along with two phases of the 2.4 GHz clock. Correspondingly, data is sent from a particular AMB IC to the Memory Controller with a similar source clock strategy.

Clocking of data, over the channel, is accomplished with two phase 2.4 GHz clock signals. The two clock phases are generated from a multiplying phase-locked loop from an external 400 MHz source. In addition to the two 2.4 GHz phases, an edge aligned 400 MHz clock is provided on the channel.

Although these signals are represented as single ended entities, all channel signals can be implemented as differential CML levels.

Providing both phases of the 2.4 GHz channel clock eliminates problems associated with edge extraction and duty cycle skew adjustment at the AMB IC. Contrast this approach to one where a 2.4 GHz signal sent across the channel would require the generation of both phases within the AMB IC. Such a reconstruction of 50/50 duty cycle clocks would typically require quasi-analog circuit design techniques making the AMB IC less than straight-forward in its implementation. The elimination of data recovery circuitry within the AMB & Controller semiconductors is of huge benefit and differentiator for the new low power buffered DIMM architectures. Because of this simplification, the AMB IC can be manufactured, with low cost semiconductor processing techniques, avoiding costlier FBDIMM solutions.

With this system, electronic receivers at each end of the channel, reliably recover transmitted data. Both skew and jitter are of interest since excessive amounts of either will cause data receive errors.

Skew is the easiest to deal with since it is a byproduct of physical layout considerations. For design purposes, we can set the skew budget to be 15% of the overall data period (208.33 picoseconds). Translating 31.2 picoseconds into physical length is straightforward:

For dielectric of 3.0, propagation time is 150 picoseconds/inch

15.6 picoseconds×1 inch/150 picoseconds≈200 mils

Therefore any signal conductor within the channel high speed data group can vary by +/−100 mils and not contribute more than 31 picoseconds of skew error to the data capture.

Jitter, unlike skew, has many sources and is more difficult to access. However, the predominant generators of jitter can be listed and analyzed independently and then treated as a grand total.

The two general categories of jitter are deterministic and random. Deterministic jitter is a consequence of system design choices and includes power supply ripple, transmission line impedance mismatches, data encoding methods, receiver design and so on. Random jitter is predominantly a result of thermal noise inherent in all electrical circuits.

An important aspect with regards to random jitter is that the fewer electrical circuits involved with the transmission and reception of data, the better. In particular, complex circuits (such as DLLs and PLLs) increase the number of electrical components and as a consequence of their design, may even amplify thermal noise thereby significantly increasing random jitter. As an example, one can investigate the RMS jitter of a commercially available PLL designed for high speed applications and calculate the allowable jitter for a memory application.

First, one must become acquainted with the relationship between Burst Error Rates (BER), peak-to-peak jitter and RMS jitter

For a memory sub system it is important that the channel for delivering data to/from the CPU is error free since many implementations do not provide for error correction (especially in low-end systems). Using a 10 year timeline for the occurrence of a single error at a rate of transfer of 4.8 Gb/s yields a BER requirement of 6.6×10⁻¹⁹ for the channel.

Some of the best standalone PLLs have RMS jitter specifications of approximately 1 picoSeconds (RMS). Translating this to peak-to-peak jitter requires the BER specification as well

τ_{Random Jitter(peak-to-peak)}=1 pS (RMS)*(α=18.7 for BER of 1×10⁻¹⁹)=18.7 pS

While a random peak-to-peak jitter of 18.7 pS would be acceptable in a system with a clock period of 208.33 pS, unfortunately a combined analog/digital semiconductor does not provide the same level of noise isolation between analog and digital sections. The RMS noise level of a PLL on a die with digital switching noise may be up to a factor of 2 to 3 higher than a standalone implementation. Taking this into account it is conceivable that a AMB IC with a built-in PLL would have a peak-to-peak jitter budget of nearly 47 pS (or nearly a quarter of the clock period)!

Since the new AMB IC uses source clocking without data recovery, it avoids the problems associated with PLL induced random jitter.

Random jitter attributed to thermal noise within the data path is well below the level of affecting data recovery:

V=4kTRf is the Nyquist Noise Formula

Where k is the Boltzman constant (1.38×10⁻²³ J/K)

Where T is absolute temperature (324 deg K for 125 deg F)

Where R is the resistance of the electrical circuit (2,000 Ohms)

Diffusion is around 10 to 100 Ohms/square

Typical gate might have 10 to 20 squares
Where f is the frequency of operation (4.8×10⁹)

V=4*1.38×10⁻²³*324*2000*3.2×10⁹17.25 μV

On a “per gate” basis, the above equations indicate an 17.25 microvolt thermal noise contribution. Assuming 100 gates worth of contributing noise into the data path recovery logic, this would only amount to a little over 1 millivolt of noise.

The deterministic portion of the jitter is considered. The major sources of deterministic jitter for the system are:

Inter-Symbol Interference (ISI)

Power Supply Noise

Impedance Mismatches

Inter-Symbol Interference (ISI) is caused by a channel not responding equally to all frequencies contained in an electrical signal. As is well known, as frequencies increase, the skin effect of a conductor increases its resistance to those frequencies. However, if a signal contains lower frequencies (such as DC), there can be a significant difference between the low and high frequency impedance of the channel. The net result on a signal traversing the channel is distortion due to the difference in arrival time between the low frequency components and the high frequency components. The situation is exacerbated by impedance discontinuities which further degrade the high frequency components of a signal more significantly than the lower frequency components

To combat the DC element of signal dispersion designers often resort to encoding data to limit the bandwidth of the channel signals. Most often this entails the elimination of the DC component of the signal. For, the LB-DIMM, sophisticated encoding is not considered due to the delay a signal encoder would insert into system. Instead, due to the LB-DIMM short length of the channel and the absence of any significant impedance mismatches, no encoding is used. No attempt is made to theoretically calculate the ISI jitter due to the DC component as this quantity is more readily measured. A typical method of quantifying jitter is the “eye” chart:

A surprising advantage of this second aspect of the present invention is that by reducing the operating speeds between the memory and the memory controller, less demand is placed upon the memory chips. During the manufacture of memory chips, memory chips graded according to performance with the higher performing memory chips are able to be used in high-performance. applications. As a result of the second aspect of the present invention, a high proportion of the memory chips manufactured may be used in these high-performance applications, resulting in greater profit for the chip manufacturers as well as less wastage.

We have also found in the production of a memory module according to the first aspect of the present invention that a memory assembly may be provided without a foldable substrate using layered substrates appropriately connected and many advantages of the foldable substrate still obtained. According to a third aspect of the present invention, there is provided a memory assembly for a computing device comprising a plurality of memory chips mounted on a first substrate and a memory. buffer mounted on a second substrate wherein the second substrate is adapted to be received on a host board and the first substrate is adapted to be received on the second substrate whereby the memory chips are connected to the memory buffer and the memory buffer is adapted to be connected to the host board.

We have found is that by mounting the memory buffer on a second substrate that it might be positioned intermediate the memory chips and the host board, that we are able to provide improved thermal removal from the memory buffer. Memory buffers operate at much higher power then do the memory chips. Accordingly, the requirement for thermal removal is higher on the memory buffer and then on the memory chips.

In addition, the cost of a memory buffer exceeds the cost of the memory chips and it is also convenient to be able to replace the memory chips without the need to replace the more expensive memory buffer.

In this third aspect of the present invention, the first substrate may be foldable to deform to accommodate the second substrate positioned therebelow.

The memory assembly of these third aspect of the present invention is also particularly suited for a meeting of the memory buffer to be mounted directly on the host board. Accordingly, the advantages described in relation to the second aspect of the present invention may be obtained by mounting of the memory buffer directly on the host board. According to a fourth aspect of the present invention, there is provided a memory module for a computing device comprising a plurality of memory chips mounted on at least two substrates wherein the at least two substrates and the memory chips are layered and the at least two substrates are interconnected by a plurality of resilient members whereby the memory chips are connected to a memory buffer and whereby the memory chips are disposed in a stacked configuration and wherein the memory module is adapted to be received on a host board.

In this aspect, we have also found a memory module having a stacked array of memory chips which can be formed from discrete boards of memory chips. In traditional stacked devices, the discrete boards joined using conventional pin in socket connectors. This type of connection is not only cumbersome and but has a number of limitations that will be magnified as signal speeds continue to rise.

Traditional interconnections are most commonly made by passing signals through one external package containing the first chip down through an interconnection substrate onto which the IC package is electrically and mechanically interconnected across the substrate and up through interconnections and then up into a second IC containing externally leaded package. This is generally regardless, of the package type or board construction; moreover the interconnection substrate is shared by many different IC and discrete components. As signal processing speeds continue to rise this approach is proving to be problematic. Thus, the traditional approach to interconnection fails to deliver lower power and higher bandwidths required for electronic devices.

These limitations are understood to be the result of the individual and compound effects of a number of different physical and electrical/electronic design elements including: impedance discontinuities associated with signals, connector and interconnection substrate, varied path lengths of different signals, design rule variations associated with different electronic devices, the type of interconnection format employed (e.g. solder balls or lead frames), the effects of via stubs in both the package and board. It is generally perceived that these limitations, typical of current design and device interconnection solutions will be magnified as signal speeds continue to rise.

In summary, it is generally believed that signal transmission quality will degrade, to a point of being useless as the industry moves to high frequency (e.g. gigahertz) signal processing speeds without significant changes being made or effected in materials, connectors, design practices and manufacturing methods.

In this fourth aspect, as well as in the fifth and sixth aspects, we have provided some solutions to these problems. We have found ways of providing interconnections that allow for the connection from one chip or board to another by means of a direct link in environment that is electronically and/or physically isolated from the traditional connectors, substrate and solder balls. In addition, these interconnection technologies can help obtain high density wiring in controlled environments without going. through the via-stubs. Moreover, such chip to chip or chip to board or board to board interconnections can be made, between differing substrates and assemblies (e.g. memory modules, mother boards, MCM, etc).

The resilient members for use in this aspect of the present invention may be of any convenient configuration whereby the respective substrates may be electrically connected in a resilient manner whereby the substrates when pressed together are held in that pressed arrangement. Examples of suitable resilient members, include copper lead frames, solder ball membranes, such as those in membranes with columns of copper solder balls extending across the membrane, Microsprings as may be obtained from Form Factor Inc., alignment contact springs, flex positioned over a resilient tube and any other convenient resilient member suitable for providing electrical connection between the respective layers of substrate.

The use of resilient connectors as described with reference to the third aspect of the present invention we have found it to be applicable to the interconnection of chips and boards, as well as other elements of a computing device. According to a fifth aspect of the present invention, there is provided a connection for removably connecting elements of a computing device comprising a plurality of resilient members wherein the resilient members have at least one terminal end for resiliently engaging one element of a computing device and wherein the connection further comprises a clamp for urging and maintaining the respective elements and resilient member into electrical contact.

The respective substrates may be held together using any convenient mooching and clamping means. Suitable clamps might provide a means to urge the substrates onto the host board and retain them in place with a suitable clip or clasp.

According to a sixth aspect of the present invention, there is provided a connection for removably connecting elements of a computing device comprising at least one spacer, each spacer having a plurality of conductive members wherein the conductive members are formed from nanostructure materials and have at, least one terminal end for resiliently engaging one element of a computing device and wherein the connection further comprises a clamp for urging and maintaining the respective elements and resilient member into electrical contact.

Nanostructure materials suitable for electrically connecting respective substrates may include a variety of materials including carbon nanotubes, nanowires, nanocoils and nanosprings. These materials may preferably be embedded in an insulating material to provide a structural support for the nanostructures. The nanostructures embedded in the insulating material may conveniently provide a sacer to retrain the substrates in a desired position.

In the fifth and sixth aspects of the invention, we have been able to obtain high speed, low power interconnections by means of discrete and direct electronic interconnection paths. The chip packages or multi-package boards have interconnections that are removable and unable one or more of the chip packages or multi-package boards to be removed and replaced. The interconnections may be by way of resilient members or nano structured materials.

### BRIEF DESCRIPTION OF THE FIGURES

FIG. 1 shows a memory module of the prior art;

FIG. 2 shows a memory module according to one embodiment of the first aspect of the present invention;

FIG. 3 shows a memory module according to another embodiment of the first aspect of the present invention;

FIG. 4 shows a memory module according to one embodiment incorporating both the first and third aspects of the present invention;

FIG. 5 shows a memory module according to another embodiment of the first aspect of the present invention;

FIG. 6 shows a memory module according to one embodiment of the third aspect of the present invention;

FIG. 7 shows the attachment of memory modules of the first aspect of the present invention to a host board;

FIG. 8 shows a schematic diagram of the application of the memory module of the present invention;

FIG. 9 shows a memory module according to another embodiment incorporating both the first and third aspects of the present invention;

FIG. 10 shows a memory module according to one embodiment of the third aspect of the present invention;

FIG. 11 shows a memory module according to one embodiment of the fourth aspect of the present invention;

FIG. 12 shows a memory module according to another embodiment of the fourth aspect of the present invention;

FIG. 13 shows a memory module according to another embodiment of the fourth aspect of the present invention;

FIG. 14 shows a connector according to one embodiment of the fifth aspect of the present invention;

FIG. 15 shows a connector according to another embodiment of the fifth aspect of the present invention as well as a memory module according to another embodiment of the fourth aspect of the present invention;

FIG. 16 shows a connector according to another embodiment of the fifth aspect of the present invention as well as a memory module according to another embodiment of the fourth aspect of the present invention;

FIG. 17 shows a connector according to another embodiment of the fifth aspect of the present invention;

FIG. 18 shows a connector according to one embodiment of the sixth aspect of the present invention;

FIG. 19 shows a connector according to another embodiment of the sixth aspect of the present invention;

FIG. 20 shows a connector according to another embodiment of the sixth aspect of the present invention;

FIG. 21 shows a connector according to another embodiment of the sixth aspect of the present invention; and

FIG. 22 shows a schematic diagram of the connection the plane and a memory buffer and a memory controller according to the second aspect of the present invention.

### BEST METHOD OF PERFORMING THE INVENTION

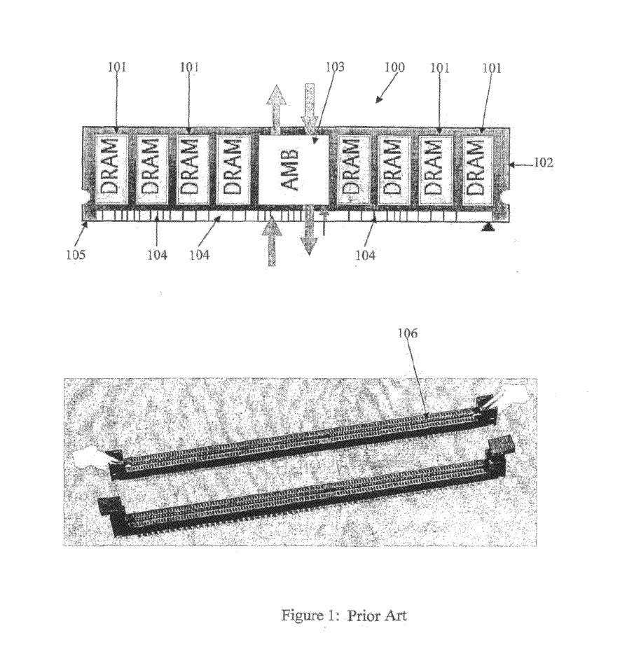

FIG. 1 shows a prior art memory module 100 having DRAM memory chips 101 mounted on a PCB 102. An AMB memory buffer 103 is also mounted on the PCB 102. The memory module 100 has connections 104 positioned along the bottom edge 105.

The memory module 100 is received in the socket 106 to provide electrical connection between the circuit board (not shown) and the memory module 100.

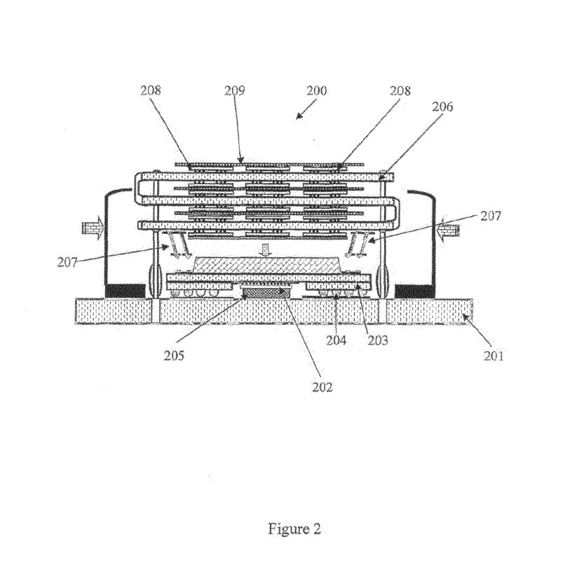

FIG. 2 shows a memory module 200. A host PCB board 201 has the memory module 200 mounted thereon. A memory buffer 202 is mounted on a substrate 203 that is physically and electrically connected to the host PCB board by solder balls 204. The memory buffer 202 is mounted against a thermal relief device 205 for a thermal attenuation of heat generated by the memory buffer 202.

A folded substrate 206 is connected to the substrate 203 on which the memory buffer 202 is mounted by self alignment contact mechanisms 207. The self alignment contact mechanisms 207 are resilient members having an electrical contact applied thereto, providing electrical connection as well as an alignment.

The folded substrate 206 has a plurality of memory chips 208 mounted on it. The memory chips 208 form three distinct stacks. The memory chips mounted on adjacent layers of the folded substrate 206 are separated by thermal relief boards 209.

FIG. 2 shows an example of a board to board interconnection structure interconnected by separable or permanent flex cables to route high and low speed interconnections between systems/boards. Interconnections can be made through both ends of the substrates or through PCB boards on the top and bottom surfaces. For example, wherein interconnections are made in line with substrate 203 (where the advanced memory buffer chip 202 is soldered), having only necessary signals brought to the mother board through solder balls 204.

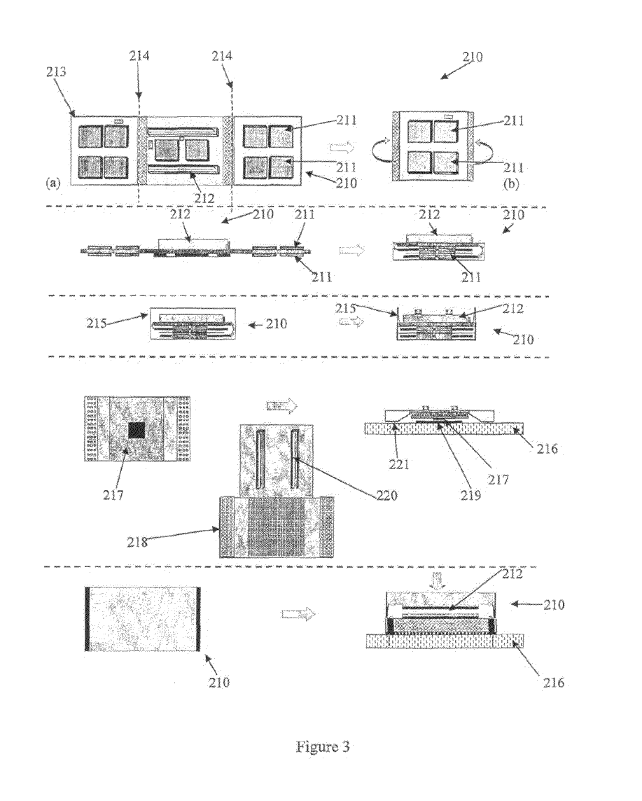

FIG. 3 shows a memory module 210 in various stages of construction. At (a) the foldable substrate 213 is in an unfolded form with the memory chips 211 disposed in a dual array as viewed from the top. The memory module 210 has two connectors 212 extending from the foldable substrate 213. The foldable substrate 213 is folded along fold lines 214 as shown in a top view at (b). Blades 215 extend from the memory module and allow the alignment of the memory module 210 with the highest board 216 and the memory buffer 217.

The memory buffer 217 is attached to a foldable substrate 218 and mounted on the host board 216. The memory buffer 217 is mounted on a heat sink 219 and the foldable substrate 218 is attached to the host board by gold bumps 221.

The memory module 210 is mounted on the host board 218 by connectors 212 in two opposed connectors 220 mounted on the foldable substrate 218.

This is an example of a fully buffered memory module. DRAM Memory devices are interconnected through connectors at the top of the AMB device. A flexible trace passing through the lower module connects the high speed traces between the memory controller and the AMB device at the same time that lower speed DRAM connections will be brought to the top, through the same flex connection to the upper module.

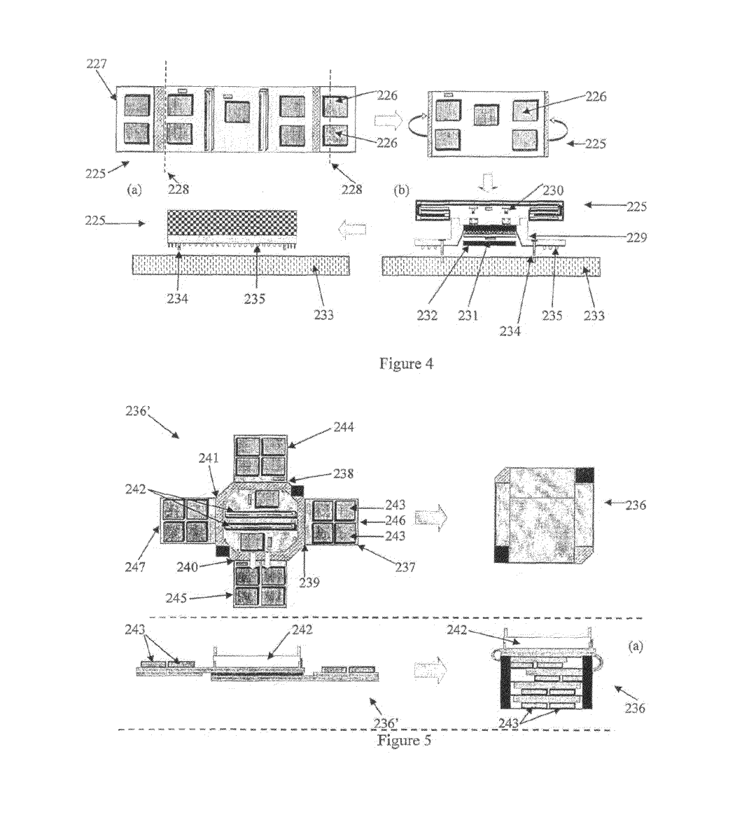

FIG. 4 shows a memory module 225. The memory module 225 has a dual array of memory chips 226. The memory module 225 is formed on a substrate 227 and is folded along with fold lines 228 to form the folded module shown at (b).

The memory module 225 is mounted on a board 229 by connectors 230. The board 229 contains a memory buffer 231 and a heat sink 232. The board 229 is mounted on a host board 233 by screws 234 to provide a physical connection and gold bumps 235 to provide the electrical connection.

This is an example of a structure with DRAM memory devices on opposite sides of a set of modules with all devices continuously constructed and them folded. Note that these devices could also be two sided assemblies with discrete flexible cables with connectors at the middles.

FIG. 5 shows a memory module 236. The unfolded memory module 236′ is on a folded substrate 237 the folded substrate has four fold lines 238, 239, 240 and 241 respectively. The folded substrate also has two connectors 242. Memory chips 243 mounted on a the folded substrate 237 in a dual array.

The respective arms 244, 245, 246 and 247 are folded sequentially to form a stacked array in the folded memory module 236 as viewed from the side at (a).

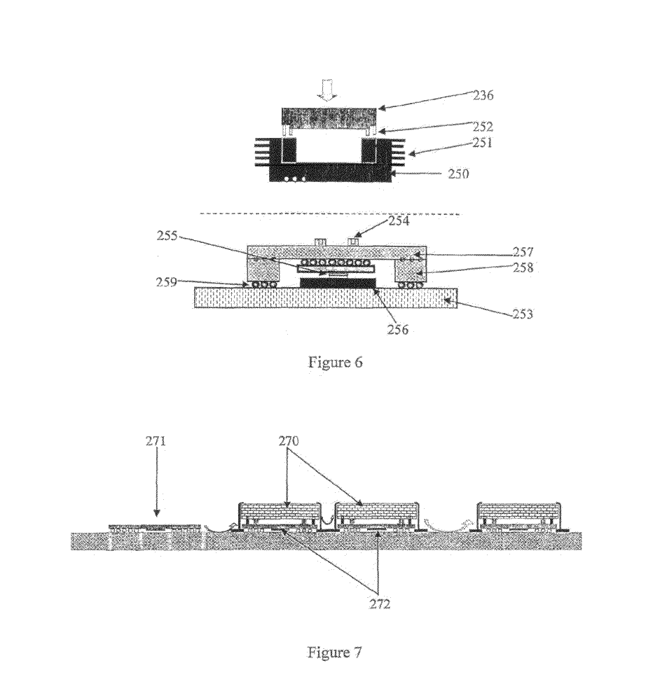

The folded memory module 236 is inserted into a connector 250 shown in FIG. 6. The connector 250 has cooling fins 251 extending therefrom and engages with the connector pins 252 connected to thermal layers disposed between the respective memory chips 243.

The electrical connection between the memory module 236 and the memory buffer is by connector pins 254 which engage corresponding connector pins on the memory module 242. A memory buffer 255 is mounted on a thermal relief 256 and connected to a printed circuit board 257. The printed circuit board 257 is connected to circuit boards 258 which are in turn connected to the host board 253 is by a lead free BGA balls 259.

This shows a high speed connection between the module and the memory controller by the use of a rigid construction where an integral PCB design is provided on the module allowing it to be directly connected to the memory controller.

FIG. 7 shows a communications channel for a memory system consisting of a high speed physical channel interposed between memory bricks 270 and a memory controller 271. One embodiment becomes the basis for what is referred to as a next generation memory brick. Use of a high speed fully buffered point to point interconnect provides for substantial memory system performance improvements with the following features:
Point-to-point connections between devices allowing higher electrical switching performance
An extremely fast (>2 Gbit/pin) channel between the controller and next generation lower power Advanced Memory Buffer (XAMB) devices 272 which has substantial margin for improvement beyond 2 Gbit/pin.
It delivers the aggregated bandwidth, substantially higher performing memory system are possible with current DDR SDRAMs or other memory types.
Scalability in both bandwidth and memory size via simple change out of the next generation memory stack brick assemblies instead of large design changes and design cycles. Controller can be design for variable high speed link and DRAMs remain unchanged as bandwidth capability increases.
Simplified memory module design with low form factor

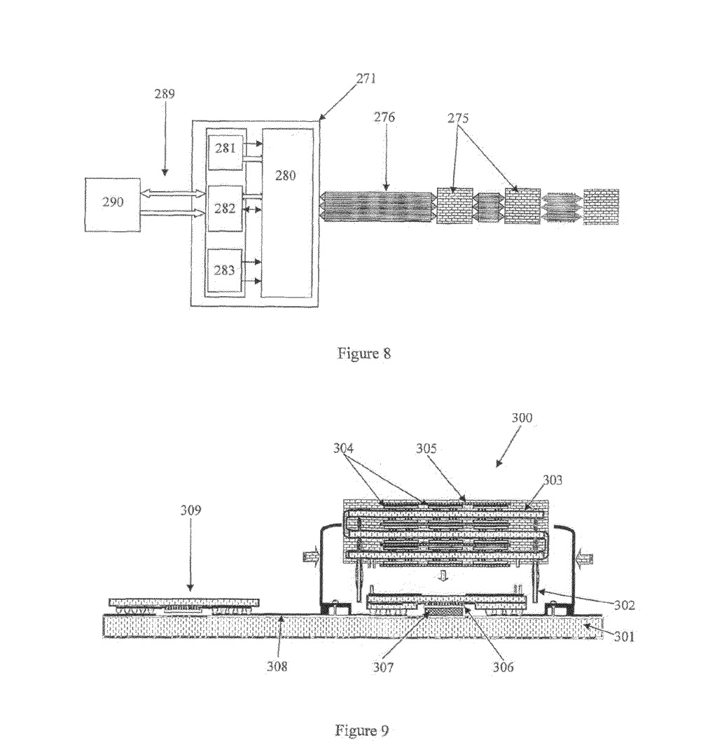

FIG. 8 shows a stack brick implementation. The fully buffered (FB) DIMM connector is replaced by direct clean channel connections which exist between a next generation fully buffered memory controller 271 and the new Stack Brick DIMMs 275. The fully buffered memory controller 271 contains a low power advanced memory buffer transceiver portion 280, an address decode and multiplexer portion 281, a data channel portion 282, and a timing and control portion 283. The fully buffered memory controller 271 communicates directly with a CPU 290 via a front side bus 289.

Through low power differential drivers, the standard serialised memory. control signals are transported through a “clean” transmission channel 276 whereby they are terminated at identical XAMB devices 272 (contained within the stack brick and not shown in FIG. 8). The “clean” transmission channel 276 denotes a channel without significant impedance variations or stubs. Such a channel can be built from common flexible (Flex) circuit technologies.

The semiconductors at both ends of the Stack Brick regenerate the standard memory control and data signal connections, these terminating advanced memory buffer devices provide point-to-point connections to each of the Stack Brick DIMMs 275. By this arrangement, the Stack Brick DIMM module 275 becomes sequentially accessible, dramatically increasing bandwidth. The Stack Brick provides these additional benefits:
The controller 271 and the XAMB devices 272 pin count remains relatively constant despite lower power and additional bandwidth.
Motherboards become simpler—The Stack Brick removes high speed signals from the motherboard and enables the Stack Brick DIMM module 275 to be placed on or off of the motherboard.
There are no minimum Stack Brick DIMM 275 size requirements
   A size Stack Brick DIMM 275 can be installed for minimum systems.
Stack Brick technology is independent of standard memory interface standards. DRR-2, DDR-3, etc . . . can be implemented using the Stack Brick

The Stack Brick is possible due to the inherently fast channel enabled by the large reduction of impedance disturbances and stubs in between the memory controller 271, integrated circuit, and the next generation memory buffer integrated circuits.

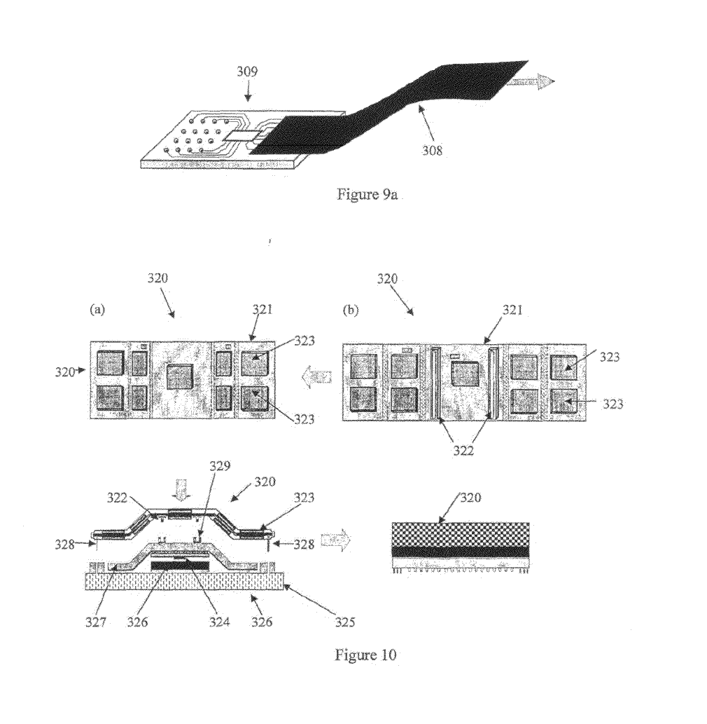

FIG. 9 shows a memory module 300 according to the invention. The memory module 300 is inserted physically into a host board 301 with pins 302. The memory module 300 is formed from a folded board 303 with memory chips 304 mounted thereon. Thermal relief is provided throughout the memory module by thermal sheets 305. The memory module is electrically connected to a memory buffer 306. The memory buffer 306 is mounted on a thermal relief 307 and the memory buffer 306 is connected to a memory controller chip by a micro strip 308. The micro strip 308 is shown in more detail in FIG. 9a.

FIG. 10 shows a memory module 320 formed by a foldable substrate 321 on which there is mounted to connectors 322 as viewed from the top at (a) and the bottom at (b). The foldable substrate includes a dual array of microchips 323. A memory buffer 324 is mounted on a host board 325 on a thermal relief 326. The memory buffer 324 is electrically connected to the host board at 325 by a board 327. The memory module 320 is formed to correspond with the shape of the board 327 and is pressed into engagement with board 327 whereby the connectors 322 engage with corresponding connectors 329 on the board 327. The pins 328 on the board 327 engage with corresponding connectors on the host board 325. This shows a memory assembly where the memory modules 320 are interconnected at the sides of the memory buffer (AMB) 324.

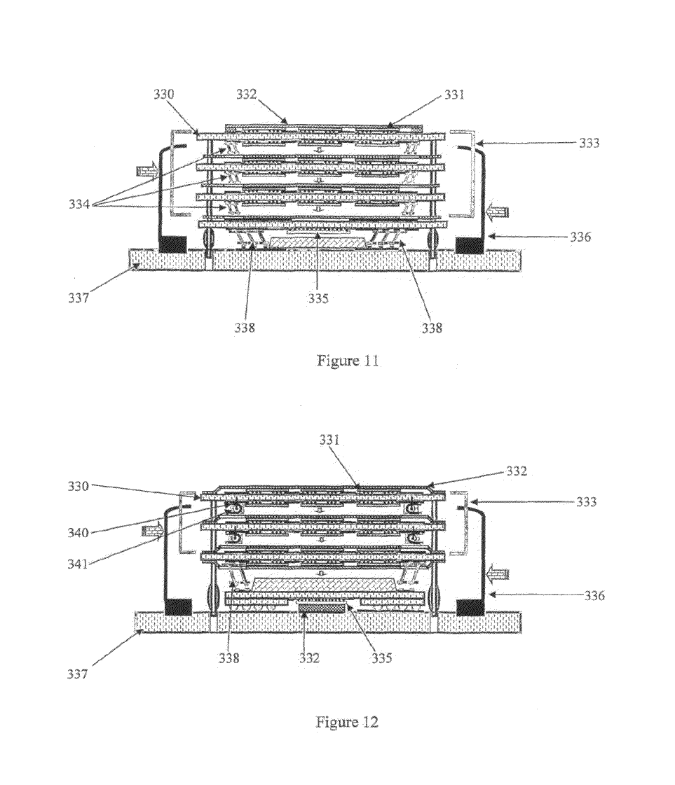

FIG. 11 shows an example of a board to board interconnection using connectors according to the aspect of the present invention. PCB boards 330, each carrying an array of memory chips 331 and separated by thermal relief 332 are pressed together and held in place by a clip 333. The electrical connection between the boards 330 is provided by alignment contact springs 334. The alignment contact springs 334 formed from a resilient material and include an electrically conductive layer that provides the electrical contact therebetween.

The boards 330 are mounted on a board 337 on which is mounted a memory buffer 335. The block of boards 330 is held on the memory buffer 335 by a PCB clamp 336. Electrical contact between the block of boards 330 and the memory buffer 335 is also provided by alignment contact springs 338.

FIG. 12 shows a similar construction to FIG. 11 but with the electrical connections between the boards 330 formed from a length of flex 340 bent around resilient tube 341.

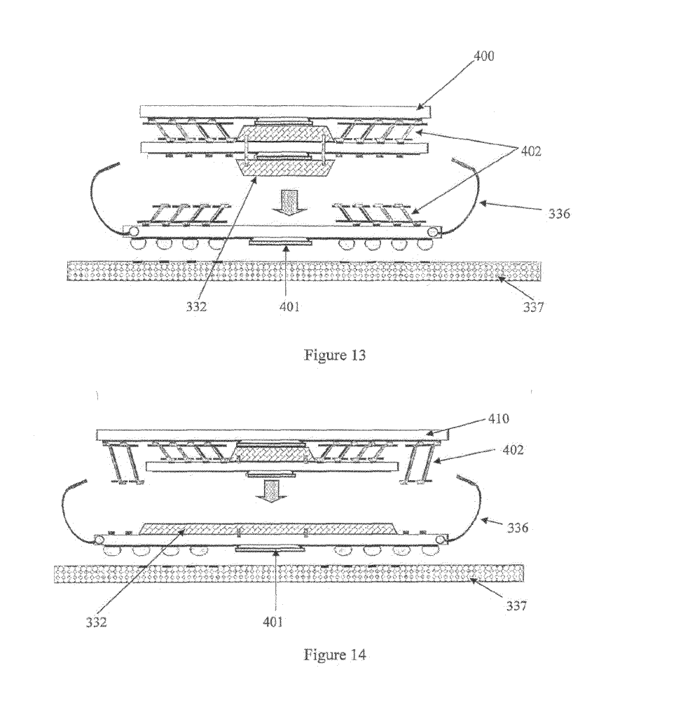

FIGS. 13 and 14 show an IC package 400 and 410 respectively connected to a silicon device 401 by alignment contact springs 402 of a similar type to that shown in FIG. 11.

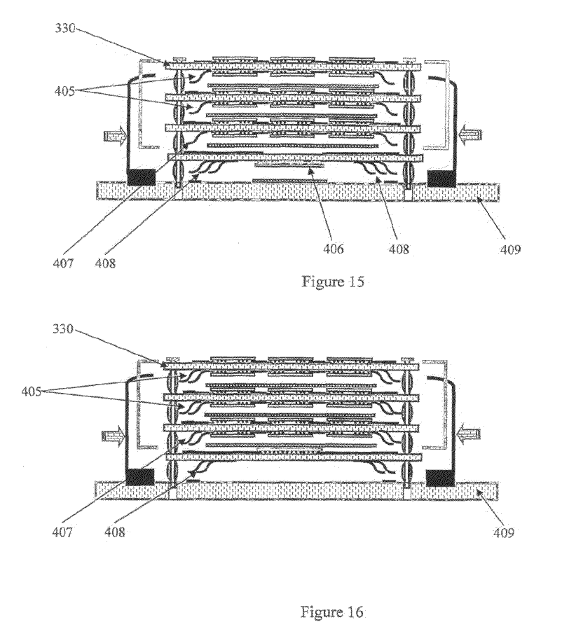

FIGS. 15 and 16 show another variation of the board to board connections. The PCB boards 330 are interconnected by resilient springs 405 and the block of PCB boards 330 are connected to the memory buffer 406 by resilient springs 407. The memory buffer 406 is connected to the host PCB motherboard 409 by an array of resilient springs 408.

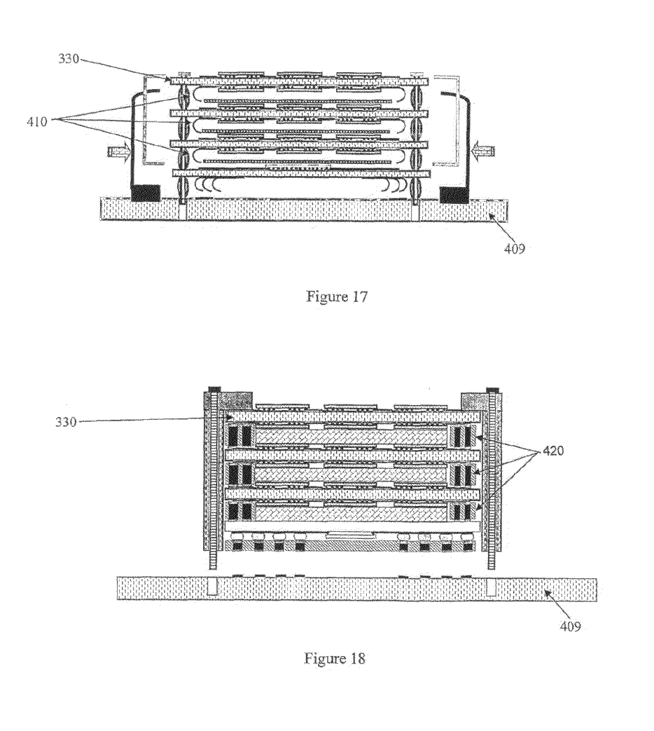

FIG. 17 shows another variation using a C shaped resilient spring 410.

FIG. 18 shows in the PCB boards 330 interconnected by spacers 410. The spacers 420 formed from carbon nanotubes embedded in an array within an expanded PTFE foam.

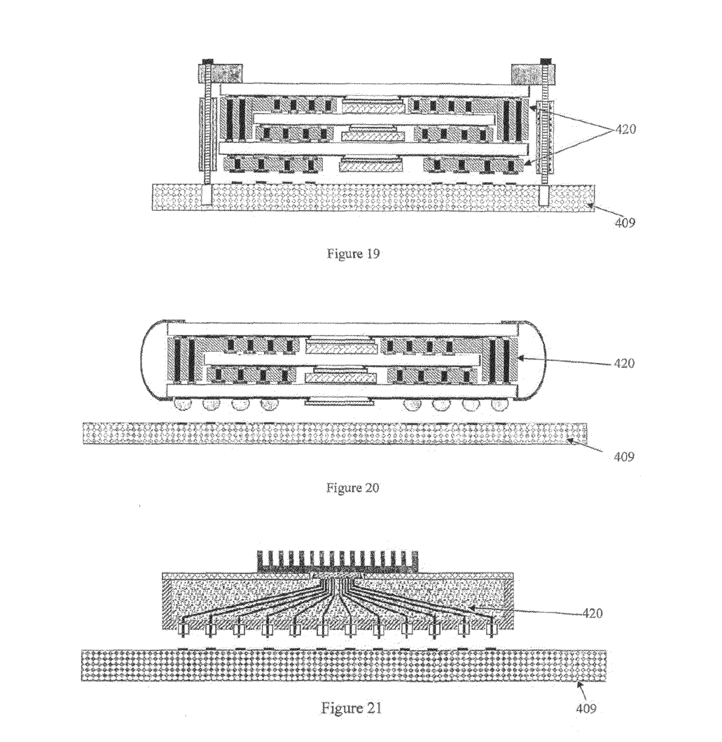

FIGS. 19 , 20 and 21 show integrated circuit packages that are interconnected using spacers of the type shown in FIGS. 18.

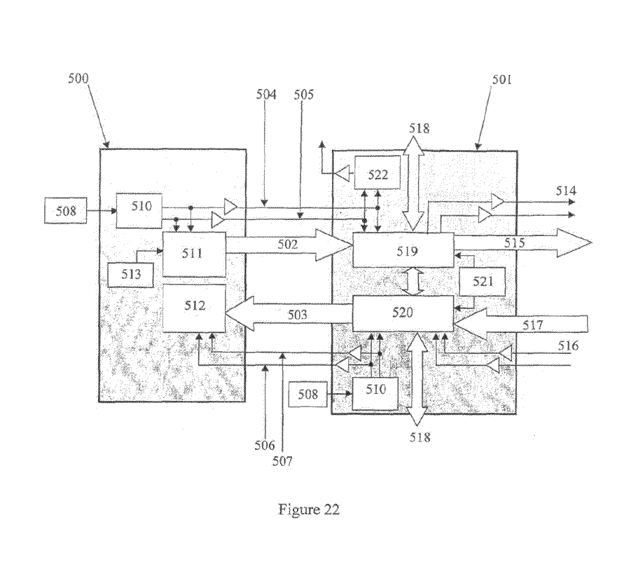

FIG. 22 shows a communication channel of a memory system of the type described above. Write data 502 from a memory controller 500 is sent to an AMB 501 along with two phases of a 2.4 GHz clock 504 and 505. Correspondingly, read data 503 is sent from the AMB 501 to the memory controller 500 with another two phases of a 2.4 GHz clock 506 and 507.

The clock phases are generated from a 400 MHz source 508 inputted to multiplying phase-locked loops 510.

In addition to the multiplying phase-locked loop 510, the memory controller 500 contains a data generation and logic portion 511, a data recovery and logic portion 512, and a calibration logic portion 513.

The AMB 501 has clock outputs 514 and a burst write data output 515 and corresponding clock inputs 516 and a burst read data input 517. Furthermore, the AMB 501 also has DRAM data input/outputs 518.

In addition to the multiplying phase-locked loop 510, the AMB 501 contains a data recovery or pass-through logic portion 519, data generation or pass-through logic portion 520, a calibration logic portion 521, and a divider and phase generator portion 522.

1-7. (canceled)

8. A memory module for a computing device comprising a memory buffer and a plurality of memory chips, wherein the memory buffer is configured to be directly mounted on a host board with a flat connection and wherein at least one of the plurality of memory chips is removably mounted on the memory buffer.

9. A memory assembly for a computing device comprising a plurality of memory chips mounted on a first substrate and a memory buffer mounted on a second substrate, wherein the second substrate is adapted to be mounted on a host board such that the memory buffer is electrically connected to the host board, and the first substrate is adapted to be removably mounted on the second substrate such that the memory chips are electrically connected to the memory buffer.

10. The memory assembly of claim 9, wherein the first and second substrates are PCBs.

11. The memory assembly of claim 9, wherein the first substrate is foldable.

12. The memory assembly of claim 9, wherein the first substrate comprises at least two electrically connected substrate components.

13. The memory assembly of claim 12, wherein the substrate components are in stacked configuration.

14. The memory assembly of claim 13, wherein the substrate components are electrically connected by nanotubes or nanosprings.

15. The memory assembly of claim 12, wherein the substrate components are flexibly connected.

16. The memory assembly of claim 15, wherein the substrate components are connected by a flexible PCB.

17. The memory assembly of claim 9, wherein the memory chips are DRAM chips.

18. The memory assembly of claim 9, wherein the memory chips are mounted in stacked configuration on the first substrate.

19. The memory assembly of claim 9, wherein the second substrate is permanently mounted on the host board.

20. The memory assembly of claim 9, wherein the host board is a PCB.

21. The memory assembly of claim 20, wherein the host board is a computer motherboard.

22. The memory assembly of claim 20, wherein the second substrate is electrically connected to the PCB by a pin, land, or ball grid array.

23. The memory assembly of claim 9, further comprising a thermal relief device.

24. The memory assembly of claim 23, wherein the thermal relief device includes a heat sink.

25. A memory module for a computing device comprising a memory buffer mounted on a substrate, and a plurality of memory chips mounted on at least two other substrates, wherein the substrates are disposed in a stacked configuration and interconnected by a plurality of resilient members and wherein the memory chips are electrically connected to the memory buffer.
